(19) United States
(12) Patent Application Publication
(10) Pub. No.: US 2011/0199911 A1
(43) Pub. Date: Aug. 18, 2011

(54) Network fault detection system

(75) Inventor: Satoshi Ikada, Nara (JP)

(73) Assignee: OKI ELECTRIC INDUSTRY CO., LTD., Tokyo (JP)

(21) Appl. No.: 12/929,357

(22) Filed: Jan. 19, 2011

(30) Foreign Application Priority Data
Feb. 18, 2010 (JP) 2010-033538

(51) Int. Cl. H04L 12/26

(52) U.S. Cl. 370/242

(57) ABSTRACT

A network fault detection system includes a parameter extractor and a fault classifier. The extractor extracts a parameter value of a parameter for use in a classification feature vector from a packet received from a network. The parameter value relates to at least one of a first value for a first parameter associated with loss of packets, a second value for a second parameter associated with jitter among packets, and a third value for a third parameter associated with a characteristic of the occurrence of the loss of packets. The classifier determines whether or not a fault has occurred in the network and classifies the fault by type, based on numerical conditions and the parameter value.

### CROSS-REFERENCE TO RELATED APPLICATION

This application claims priority under 35 U.S.C. §119 of prior Japanese Patent Application No. P 2010-033538, filed on Feb. 18, 2010, the entire contents of which are incorporated herein by reference.

### BACKGROUND OF THE INVENTION

1. Field of the Invention

This application relates to a system for detecting a fault that has occurred in a network.

2. Description of the Related Art

Services that stream multimedia data, such as audio data or moving image data, in real time over a network have expanded recently. In order to maintain the quality of the services, it is important to detect a fault in the network properly and respond to it promptly. Japanese Laid-Open Patents No. 2008-042470, No. 2009-219075, and No. 2006-005775 disclose systems that detect a fault in a network.

The system disclosed in the publication No. 2008-042470 sends packets that have a variety of conditions to detect a fault in a network to devices on the network, and analyzes reply signals from the devices, thereby detecting the fault. In this system, however, the packets for detecting the fault continue to be sent over the network, resulting in heavy communication traffic.

The system disclosed in the publication No. 2009-219075 monitors loss of packets that flow in the vicinity of a predetermined node (a device) and that are generated based on the RTP (Real-time Transport Protocol), jitter among the packets, and round trip times in a network, thereby detecting a fault. In this system, however, the detection accuracy is liable to vary depending on the characteristics of the network, such as wired communications, wireless communications, performance of devices on the network, the number of hops or the like. In addition, the system detects the fault end-to-end. Therefore, the system has trouble identifying the location of the fault in the network.

The system disclosed in the publication No. 2006-005775 detects a fault in a network based on whether or not a predetermined number of packets have been lost in series, i.e., whether or not a burst error has occurred. In this system, a link failure may occur due to poor reception of radio waves in wireless communications. In the link failure, though, packets are not necessarily lost in series, because a normal link state and a state in which some packets are lost alternate. Therefore, the system is unable to detect a fault when a link failure has occurred.

### SUMMARY OF THE INVENTION

An object of the application is to disclose a network fault detection system that is capable of detecting a fault properly and in detail.

In one aspect, a network fault detection system includes a parameter extractor and a fault classifier. The extractor extracts a parameter value of a parameter for use in a classification feature vector from a packet received from a network. The parameter value relates to at least one of a first value for a first parameter associated with loss of packets, a second value for a second parameter associated with jitter among packets, and a third value for a third parameter associated with a characteristic of the occurrence of the loss of packets. The classifier determines whether or not a fault has occurred in the network and classifies the fault by type, based on numerical conditions and the parameter value.

In another aspect, a network fault detection system for use with a network includes a computer that includes a parameter extractor and a fault classifier. The parameter extractor extracts parameter values from a packet received from the network. The parameter values extracted from the packet are selected from a group that includes parameter values associated with loss of packets, parameter values associated with jitter among packets, parameter values associated with an occurrence of the loss of packets, and parameter values associated with transmission delays. The fault classifier determines whether or not a fault has occurred based at least in part on the parameter values extracted from the packet received from the network and a classification rule that employs the parameter values extracted from the packet received from the network.

The full scope of applicability of the network fault detection system will become apparent to those skilled in the art from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The network fault detection system will be more fully understood from the following detailed description with reference to the accompanying drawings, which are given by way of illustration only, and should not limit the invention, wherein:

FIG. 1 is a block diagram of a network fault detection system of a first embodiment;

FIG. 2A is a structure diagram of an RTCP-XR packet that has Report Blocks;

FIG. 2B is a structure diagram of the Statistics Summary Report Block in the Report Blocks;

FIG. 2C is a structure diagram of the VoIP Metrics Report Block in the Report Blocks;

FIG. 3 is an explanatory diagram of a classification rule stored in a classification condition memory;

FIG. 4 is a block diagram of a network fault detection system of a second embodiment;

FIG. 5 is a table showing values of parameters that configure classification feature vectors and classification labels stored in a classification vector memory;

FIG. 6 is a block diagram of a network fault detection system of a third embodiment;

FIG. 7 is a table showing pairs of IP addresses and the numbers of faults counted by a counter;

FIG. 8A is a pattern diagram of the topology of a network;

FIG. 8B is a table showing data corresponding to the topology stored in a network topology memory;

FIG. 9 is a pattern diagram showing relationships between nodes and IP addresses;

FIG. 10 is a block diagram of a network fault detection system of a fourth embodiment; and

FIG. 11 is a block diagram of a network fault detection system of a fifth embodiment.

### DETAILED DESCRIPTION OF THE INVENTION

Preferred embodiments of a network fault detection system according to the invention will be described in detail with reference to the accompanying drawings.

### First Embodiment

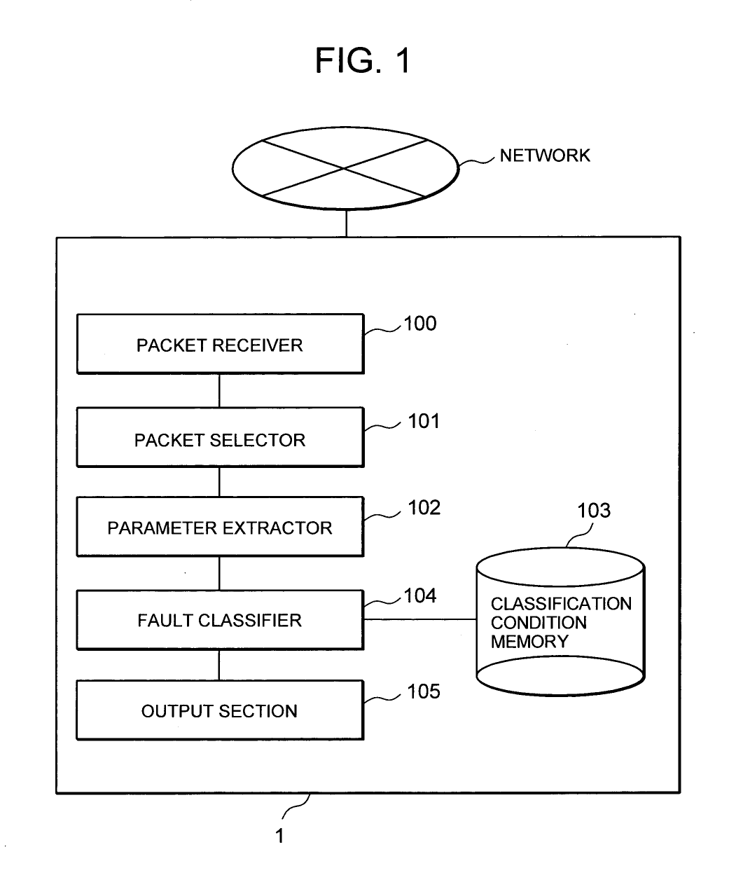

FIG. 1 is a block diagram of a network fault detection system 1 of a first embodiment, which may include a packet receiver 100, a packet selector 101, a parameter extractor 102, a classification condition memory 103, a fault classifier 104, and an output section 105.

The receiver 100 receives packets at a point on the network, and sends the received packets to the selector 101 after converting each of them into a form that can be processed by the selector as needed. The selector selects a packet, from which values of parameters are to be extracted by the extractor 102, from the sent packets based on their headers. The selected packet includes information on data-flow control and the source and destination thereof. In the first embodiment, the selected packet is an RTCP-XR (Real-time Transport Control Protocol-Extended Reports) packet, which is transmitted and received according to RTCP-XR. Hereinafter, the description will be given regarding the case where the selector selects an RTCP-XR packet.

The extractor 102 extracts values of parameters from the selected packet. These values configure a classification feature vector, which is data used to determine whether or not a fault has occurred in the network and classify the fault by type. The vector includes at least one of a value associated with loss of packets, jitter among packets, and a characteristic of the occurrence of the loss (e.g., a burst error).

The condition memory 103 stores a classification rule and numerical conditions thereof. The classifier 104 determines whether or not a fault has occurred in the network and classifies the fault by type, based on the vector and the rule. The output section 105 may display the results of classification by the classifier on a screen.

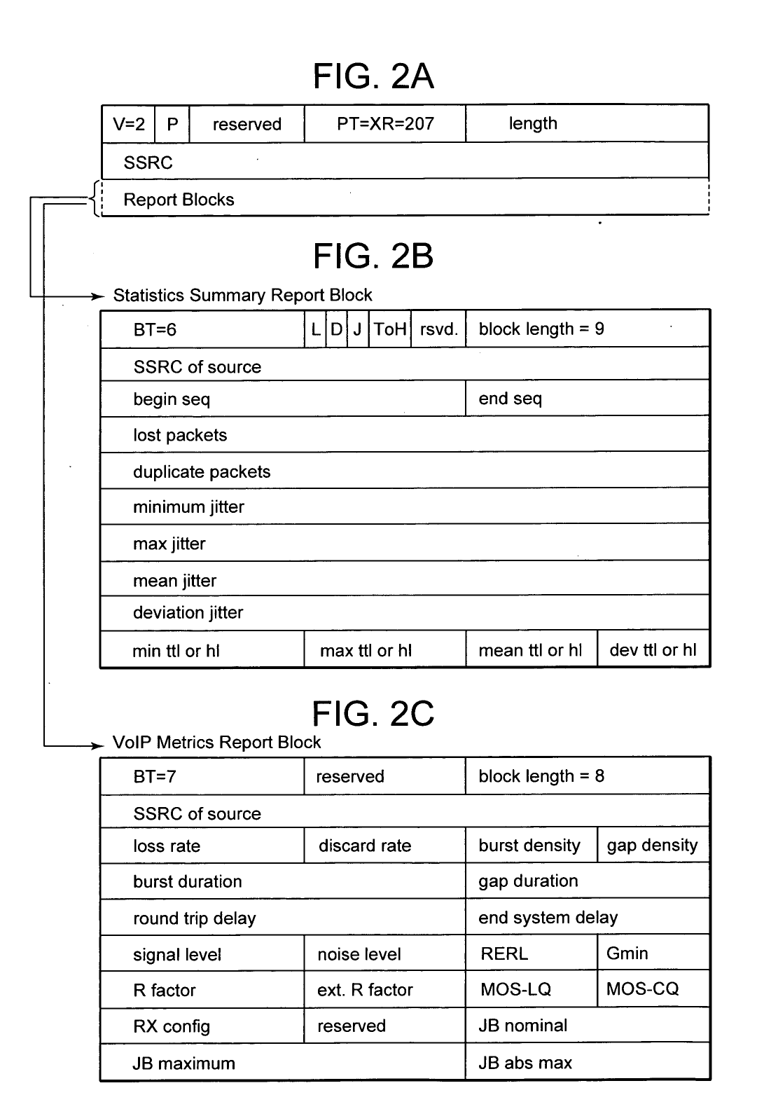

FIG. 2A is a structure diagram of an RTCP-XR packet having Report Blocks. FIGS. 2B and 2C are respectively structure diagrams of the Statistics Summary Report Block and the VoIP Metrics Report Block, both of which configure the Report Blocks.

Referring to FIG. 2A, values of parameters that configure the vector are contained in the Report Blocks. Referring to FIGS. 2B and 2C, a parameter that has a value associated with the loss of packets corresponds to the “lost-packets,” the “loss-rate,” and the “discard-rate.” A parameter that has a value associated with the jitter among packets corresponds to the “deviation-jitter,” the “mean-jitter,” and the “max-jitter.” A parameter that has a value associated with the characteristic of the occurrence of the loss corresponds to the “burst-density,” the “burst-duration,” and the “gap-density.”

The “burst-density,” the “burst-duration,” and the “gap-density” are defined by the RFC (Request For Comments) 3611 as follows. The “burst-density” means the percentage of packets lost in a burst period during which a high proportion of packets are lost, in a predetermined statistical period. The “burst-duration” means the length of the burst period. The “gap-density” means the percentage of packet lost in a gap period, which is a period other than the burst period in the statistical period. In addition, the burst period is defined by the RFC 3611, in terms of a value Gmin, as the longest sequence that (a) starts with a lost packet, (b) does not contain any occurrences of Gmin or more consecutively received packets, and (c) ends with a lost packet.

In the first embodiment, the vector is configured with the values of the “lost-packets,” the “deviation-jitter,” the “mean-jitter,” the “max-jitter,” the “burst-density,” the “burst-duration,” and the “gap-density.” Alternatively, the vector may be configured with a value of a parameter associated with transmission delays of packets.

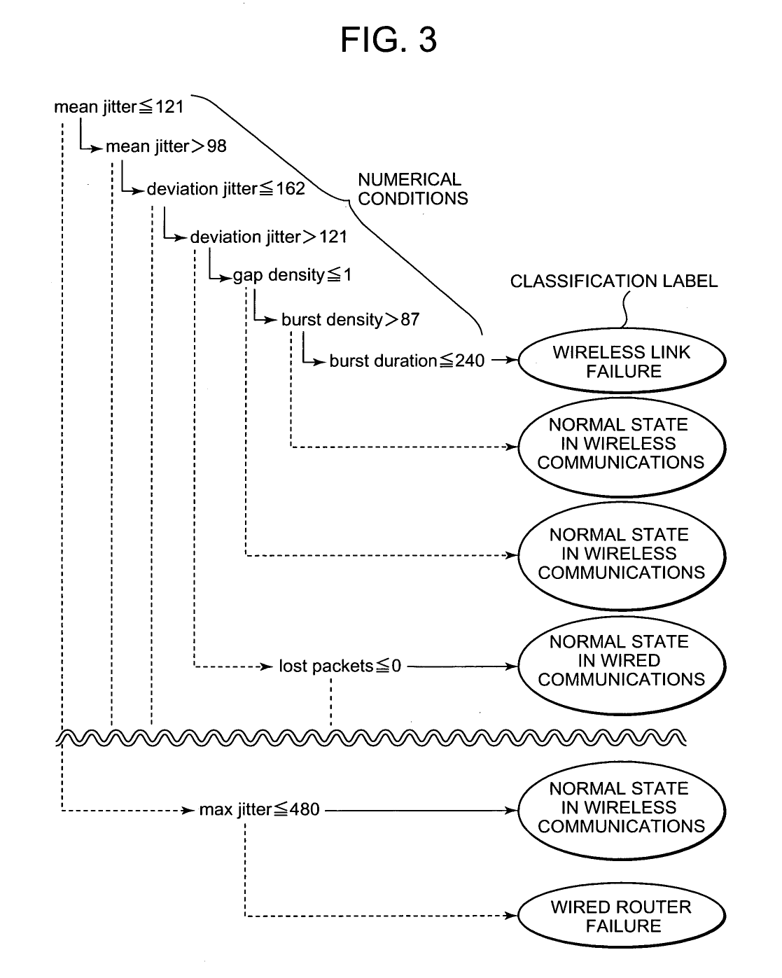

FIG. 3 is an explanatory diagram of the rule stored in the condition memory 103. In FIG. 3, a part of the diagram between wavy lines is omitted for convenience of explanation. As shown in FIG. 3, the rule has hierarchically-related numerical conditions with which the classifier 104 determines whether or not a fault has occurred in the network and classifies the fault by type. In other words, the rule defines an order in which the numerical conditions are applied. In the FIG. 3, each solid arrow shows the direction to which a process proceeds when the corresponding numerical condition is satisfied. On the other hand, each dashed arrow shows the direction to which a process proceeds when the corresponding numerical condition is not satisfied. In addition, classification labels, enclosed with solid lines, show states of the network.

For instance, FIG. 3 shows that a packet that satisfies all of the numerical conditions of “mean-jitter≦121,” “mean-jitter>98,” “deviation-jitter≦162,” “deviation-jitter>121,” “gap-density≦1,” “burst-density>87,” and “burst-duration≦240, was transmitted in a state where a wireless link failure has occurred. Each of the numerical conditions is set based on characteristics of the network in a state where no fault has occurred in wireless communications. Specifically, each numerical condition is set based on a state of the network where the mean value and the deviation value of the jitter are within a predetermined range and no loss of packets has occurred, in a predetermined statistical period. The order in which the numerical conditions are applied is not limited to the order in FIG. 3. However, it should be noted that the numerical value of each of the numerical conditions and the labels may be different from those in FIG. 3 in other orders. In addition, the rule may be defined by an “IF-THEN-ELSE” type of conditional statement.

Next, a classification process of the classifier 104 will be described with reference to FIG. 3. As shown in FIG. 3, first, the classifier determines whether or not the value of the “mean-jitter” satisfies the condition “mean-jitter≦121.” If the condition “mean-jitter≦121” is satisfied, the classifier subsequently determines whether or not the value of the “mean-jitter” satisfies the condition “mean-jitter>98.” On the other hand, if the condition “mean-jitter≦121” is not satisfied, the classifier subsequently determines whether or not the value of the “max-jitter” satisfies the condition “max-jitter≦480.” In this manner, the classifier sequentially determines whether or not each of the values of the parameters satisfies a numerical condition corresponding to each of the parameters according to the order in FIG. 3. Eventually, the classifier determines a classification label corresponding to a state of the network. If the classifier determines that a fault has occurred in the network, the classifier sends data including the content of the determined label to the output section 105.

The output section 105 displays a message about the fault on the screen based on the data from the classifier 104. At this time, in addition to the message about the fault, the output section may display information about a transmitting device and a receiving device, such as the IP (Internet Protocol) addresses of the devices, so that the location or source of the fault can be identified. This information can be extracted from the packet selected by the selector 101.

As described above, in the first embodiment, the selector 101 selects a packet that includes information on data-flow control and the source and destination thereof, from packets sent from the receiver 100. The extractor 102 extracts values of parameters, which configure the vector, from the selected packet. The classifier 104 determines whether or not a fault has occurred in the network and classifies the fault by type, based on the vector and the rule stored in the condition memory 103. Therefore, the system 1 is capable of detecting the fault properly and in detail.

In addition, the system 1 selects a packet that includes information on data-flow control and the source and destination thereof, e.g., an RTCP-XR packet, and performs the classification process on the selected packet. Therefore, the system 1 is capable of reducing its processing load, thereby preventing an increase in cost caused by enhancing the capabilities thereof.

Moreover, the vector includes a value associated with the type of loss of packets. Therefore, the system 1 is capable of distinguishing between loss of packets caused by a particular fault in the network and loss of packets caused by a link failure, in wireless communications.

### Second Embodiment

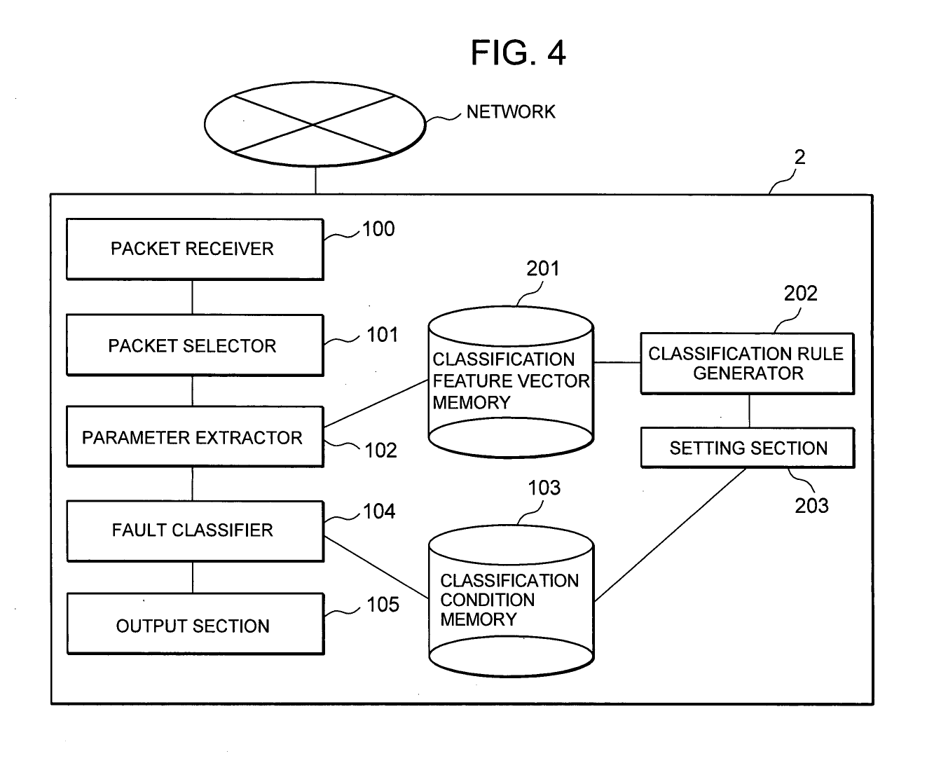

FIG. 4 is a block diagram of a network fault detection system 2 of a second embodiment, which may include a classification feature vector memory 201, a classification rule generator 202, and a setting section 203 for the rule, in addition to the packet receiver 100, the packet selector 101, the parameter extractor 102, the classification condition memory 103, the fault classifier 104, and the output section 105. In FIG. 4, elements of the system 2 similar to those of the system 1 of the first embodiment have been assigned the same reference numerals, and their description is partially omitted.

The vector memory 201 stores values of parameters, which are extracted by the extractor 102 and configure a classification feature vector. The vector memory stores the vector in association with a classification label, as described in detail later. The generator 202 generates a classification rule based on the vector and the label stored in the vector memory. The setting section 203 causes the condition memory 103 to store the generated rule.

Next, a generation process and a setting process for the rule will be described. The system 2 generates the rule based on a packet received from the network, before the classifier 104 performs the classification process.

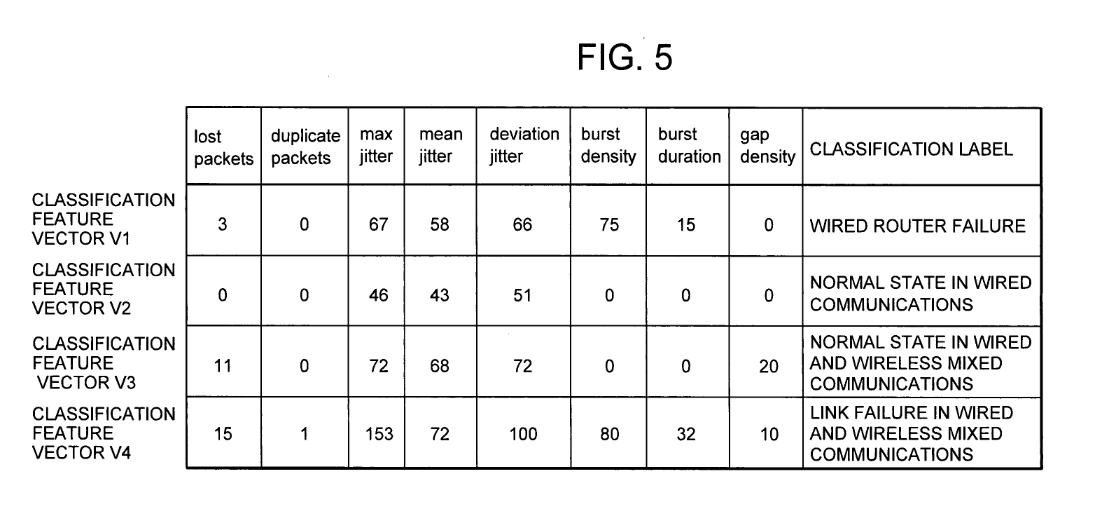

FIG. 5 is a table that shows values of parameters, which configure the vectors, and the labels stored in the vector memory 201. As described in the first embodiment, the extractor 102 extracts values of parameters from a packet selected by the selector 101. The vector memory stores the values as the vector of the extracted packet. At this time, the vector memory stores the vector in association with the label. For instance, as shown in FIG. 5, classification feature vectors V1 to V4 for different packets are respectively associated with classification labels of “WIRED ROUTER FAILURE,” “NORMAL STATE IN WIRED COMMUNICATIONS,” “NORMAL STATE IN WIRED AND WIRELESS MIXED COMMUNICATIONS,” and “LINK FAILURE IN WIRED AND WIRELESS MIXED COMMUNICATIONS.”

In the second embodiment, a system administrator associates a classification feature vector with a classification label based on the values of parameters configuring the vector, i.e., the state of a communication path over which a packet corresponding to the vector was sent.

For instance, when a packet was sent over a communication path that consists of a wired communication path, and no fault has occurred on the path, the administrator assigns a classification label “NORMAL STATE IN WIRED COMMUNICATIONS” to a classification feature vector corresponding to the packet. When a packet was sent over a communication path that consists of a wired communication path and a wireless communication path, and no fault has occurred on the path, the administrator assigns a classification label “NORMAL STATE IN WIRED AND WIRELESS MIXED COMMUNICATIONS” to a classification feature vector corresponding to the packet. When a packet was sent over a communication path that consists of a wired communication path and a wireless communication path, and a link failure has occurred on the wireless communication path, the administrator assigns a classification label “LINK FAILURE IN WIRED AND WIRELESS MIXED COMMUNICATIONS” to a classification feature vector corresponding to the packet.

The generator 202 generates the rule based on the vectors and the labels stored in the vector memory 201. In the second embodiment, the generator generates the rule with a data mining technique, such as a decision tree, a support vector machine, a neural network, a Bayesian network, or a random forest.

Here, the case where the generator 202 generates the rule with a decision tree will be described. First, if classification labels and elements (i.e., packets) of a set S are respectively designated as C1, C2, . . . , Cn, and Nc1, Nc2, . . . , Ncn, then the entropy I(Nc1, Nc2, . . . , Ncn) of the set S is calculated according to the following equation (1). It should be noted that the elements Nc1, Nc2, . . . , Ncn respectively correspond to the labels C1, C2, . . . , Cn. The symbol N in the equation (1) denotes the number of the elements of the set S (i.e., Nc1+Nc2+ . . . +Ncn).

$$I ( Nc 1 , Nc 2 , … , Ncn ) = - {\sum }_{i} \frac{Nci}{N} {log}_{2} \frac{Nci}{N} \qquad ( 1 )$$

Next, the generator 202 calculates the entropy of each parameter as follows. The generator establishes m threshold values relative to a parameter “a,” and divides the set S into m subsets S1, S2, . . . , Sm based on the threshold values. The entropy E(a) of the parameter “a” is calculated according to the following equation (2). The symbols Nsj and M in the equation (2) respectively denote the number of elements of a subset Sj and the sum of elements of the subsets S1, S2, . . . , Sm (i.e., Ns1+Ns2+ . . . +Nsm). In addition, the symbol Isj denotes the entropy of the subsets Sj.

$$E ( a ) = {\sum }_{j} \frac{{Ns}_{j}}{M} {I}_{{S}_{j}} ( Nc 1 , Nc 2 , … , Ncn ) \qquad ( 2 )$$

Next the generator 202 calculates an information gain G(a) for the parameter “a,” according to the following equation (3).

G(a)=I(Nc1, Nc2, . . . , Ncn)−E(a) (3)

Similarly to the parameter “a,” the generator 202 calculates information gains for the other parameters. The generator defines a parameter that corresponds to the largest gain among the calculated gains as a divisional parameter. Subsequently, the generator establishes multiple threshold values relative to the divisional parameter and divides the set S into multiple subsets based on the threshold values. The generator calculates information gains for all of the parameters with respect to each of the subsets, and defines a parameter that corresponds to the largest gain among the calculated gains as a new divisional parameter. The generator repeats the aforementioned procedures. Eventually, a classification label assigned to an element (i.e., packet) that remains in each of the subsets corresponds to one of the labels in FIG. 3. In addition, the threshold values established in a sequence of the procedures correspond to the numerical conditions in FIG. 3. In this manner, the generator generates the rule that has the numerical conditions and the labels.

The setting section 203 causes the condition memory 103 to store the generated rule, and the classifier 104 performs the classification process based on the stored rule.

As described above, in the second embodiment, the vector memory 201 stores the values of parameters as a classification feature vector in association with a classification label. The generator 202 generates the rule based on the vector and the label with a data mining technique. In other words, the system 2 updates the rule based on the current state of the network. Therefore, the system 2 is capable of enhancing the detection accuracy of a fault in the network.

### Third Embodiment

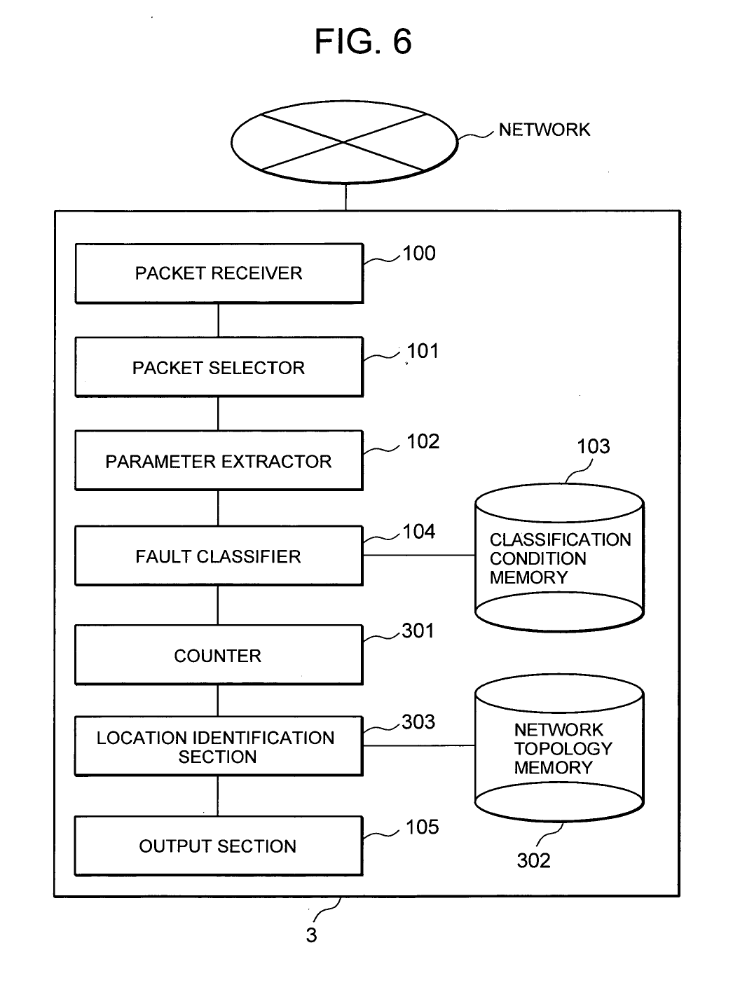

FIG. 6 is a block diagram of a network fault detection system 3 of a third embodiment, which may include a counter 301 for the number of faults, a network topology memory 302, and a location identification section 303 for a fault, in addition to the packet receiver 100, the packet selector 101, the parameter extractor 102, the classification condition memory 103, the fault classifier 104, and the output section 105. In FIG. 6, elements of the system 3 similar to those of the system 1 of the first embodiment have been assigned the same reference numerals, and their description is partially omitted.

The counter 301 counts the number of faults in a predetermined unit based on the results of classification by the classifier 104. That is, in the third embodiment, the counter counts the number with respect to each pair of IP addresses of a transmitting device and a receiving device. The topology memory 302 stores the topology of the network as data. The topology shows the actual configuration of the network, such as association between nodes or the like. The identification section 303 identifies or narrows down the location of a fault in the network, based on the communication paths on which the fault was detected and the stored topology data.

Next, an identification process for the location of a fault will be described. The system 3 detects the fault in detail and identifies the location thereof, based on the results of classification by the classifier 104.

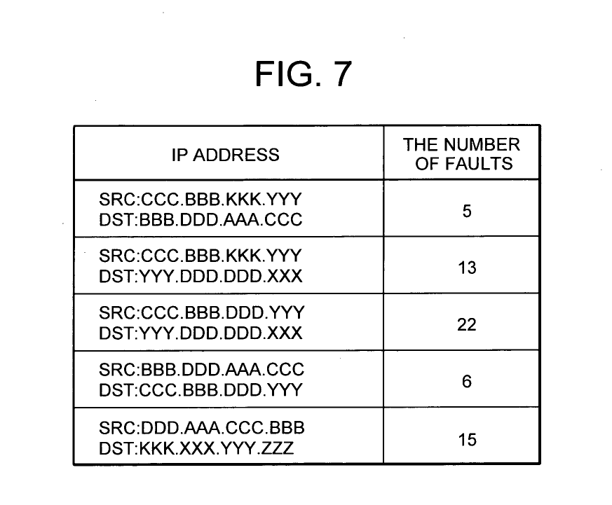

FIG. 7 is a table that shows pairs of IP addresses and the numbers of faults counted by the counter 301. For instance, if a packet was sent from a transmitting device (SRC) that has an IP address of “CCC.BBB.KKK.YYY,” to a receiving device (DST) that has an IP address of “BBB.DDD.AAA.CCC,” and the classifier 104 determined that a fault occurred on a communication path therebetween, the counter increases the number corresponding to the pair of IP addresses from five to six. If a packet was sent from a transmitting device to a receiving device, and the pair thereof has not been listed in the table, the counter adds the pair to the table and sets the number corresponding thereto to one. The identification section 303 defines a communication path (a pair of IP addresses) as an abnormal communication path when the number corresponding thereto exceeds a predetermined threshold value, and sends the results to the output section 105.

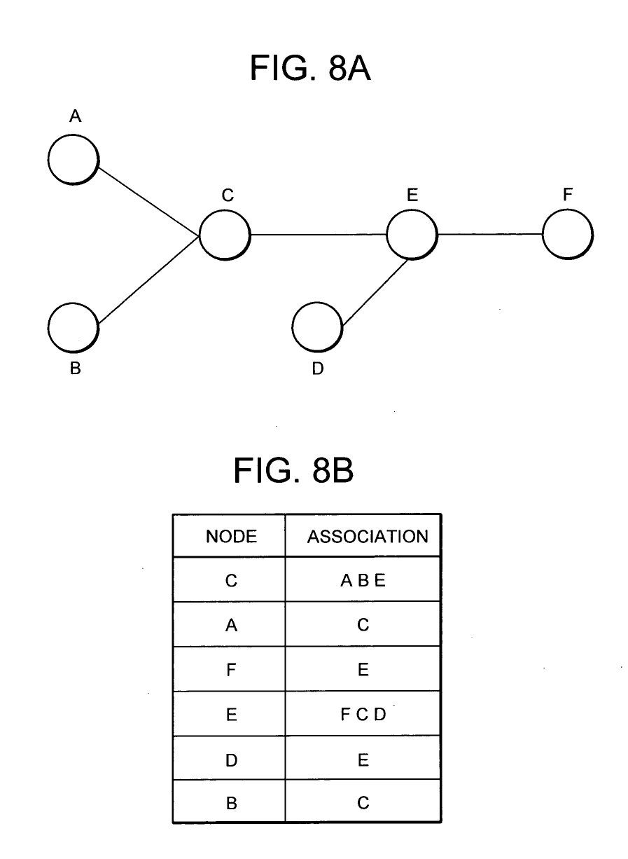

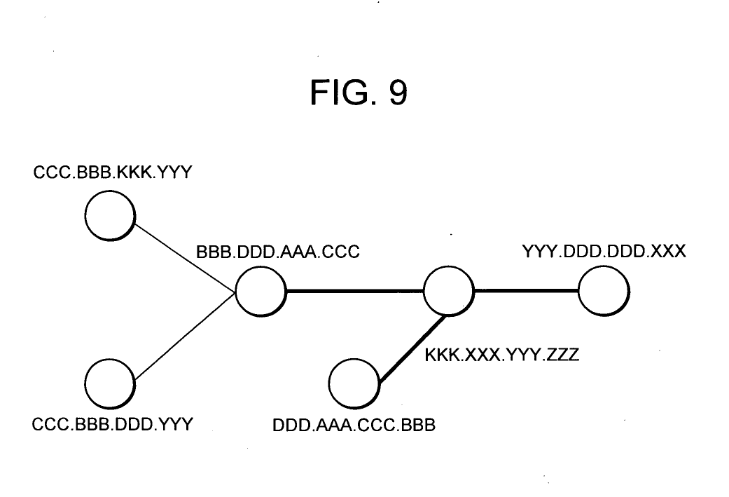

FIG. 8A is a pattern diagram of the topology of the network. FIG. 8B is a table that shows data corresponding to the topology stored in the topology memory 302. FIG. 9 is a pattern diagram that shows relationships between nodes and IP addresses.

In FIG. 9, each of the nodes may be a server or the like, and has the IP address shown in FIG. 7. Here, assuming that the threshold value for the number of faults is ten, the identification section 303 identifies the location of a fault as follows.

First, the identification section 303 defines communication paths between “CCC.BBB.KKK.YYY” and “YYY.DDD.DDD.XXX,” between “CCC.BBB.DDD.YYY” and “YYY.DDD.DDD.XXX,” and between “DDD.AAA.CCC.BBB” and “KKK.XXX.YYY.ZZZ,” as abnormal communication paths, based on the numbers of faults in FIG. 7 and the threshold value, ten. On the other hand, the identification section defines communication paths between “CCC.BBB.KKK.YYY” and “BBB.DDD.AAA.CCC,” and between “BBB.DDD.AAA.CCC” and “CCC.BBB.DDD.YYY,” as normal communication paths. According to these results, the identification section identifies a fault as being between “BBB.DDD.AAA.CCC” and “YYY.DDD.DDD.XXX,” as shown with heavy lines in FIG. 9. The identification section cannot narrow down the location of a fault between “DDD.AAA.CCC.BBB” and “KKK.XXX.YYY.ZZZ” anymore because any other normal communication paths do not exist therebetween.

If the location has been identified, the identification section 303 sends data that is used to display the communication paths on which the fault has been identified, to the output section 105. On the other hand, if the location has not been identified, the identification section sends data that is used to display the entire abnormal communication paths, to the output section.

In the third embodiment, the counter 301 may count the number of faults with respect to each AS (Autonomous System). In addition, the counter may count not only the number of faults but also the number of non-faults, i.e., the number of normal states classified by the classifier 104, and the identification section 303 may define a communication path as an abnormal communication path when the number of faults corresponding thereto is more than twice the number of non-faults.

As described above, in the third embodiment, the counter 301 counts the number of faults in a predetermined unit, i.e., with respect to each pair of IP addresses of a transmitting device and a receiving device, based on the results of classification by the classifier 104, and the identification section 303 statistically determines that a fault has occurred on a communication path when the number exceeds a predetermined threshold value. Therefore, the system 3 is capable of detecting a fault in the network more accurately.

In addition, the system 3 identifies the location of the fault with the identification section 303. Therefore, the system 3 allows a system administrator to respond to the fault promptly.

### Fourth Embodiment

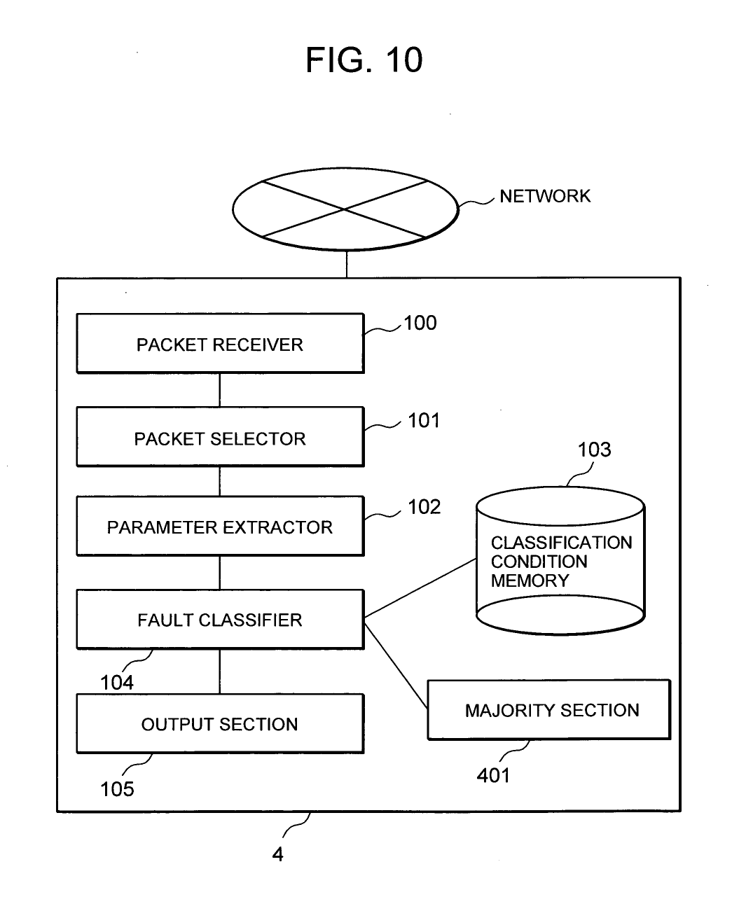

FIG. 10 is a block diagram of a network fault detection system 4 of a fourth embodiment, which may include a majority section 401, in addition to the packet receiver 100, the packet selector 101, the parameter extractor 102, the classification condition memory 103, the fault classifier 104, and the output section 105. In FIG. 10, elements of the system 4 similar to those of the system 1 of the first embodiment have been assigned the same reference numerals, and their description is partially omitted.

In the fourth embodiment, the condition memory 103 stores multiple classification rules, and the classifier 104 performs the classification process based on the rules. In this case, the classifier may determine multiple classification labels. The majority section 401 specifies a classification label most often determined by the classifier, and sends data including the content of the specified label to the output section 105.

### Fifth Embodiment

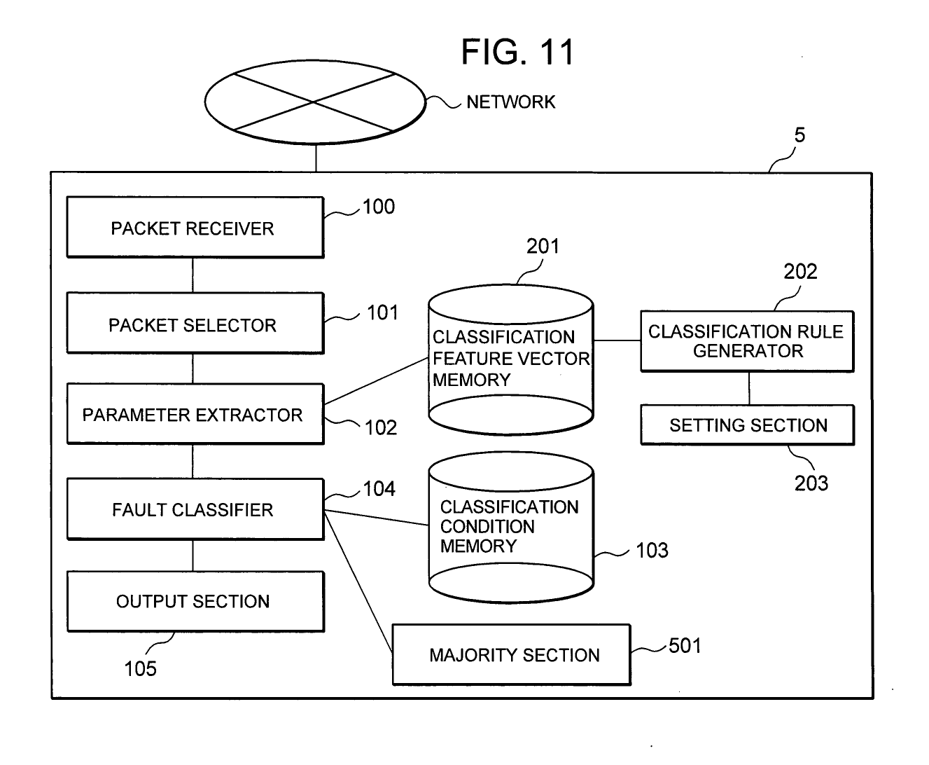

FIG. 11 is a block diagram of a network fault detection system 5 of a fifth embodiment, which may include a majority section 501, in addition to the packet receiver 100, the packet selector 101, the parameter extractor 102, the classification condition memory 103, the fault classifier 104, the output section 105, the classification feature vector memory 201, the classification rule generator 202, and the setting section 203. In FIG. 11, elements of the system 5 similar to those of the system 2 of the second embodiment have been assigned the same reference numerals, and their description is partially omitted.

In the fifth embodiment, the generator 202 generates multiple classification rules at a time with an ensemble learning method, such as a random forest, and the classifier 104 performs the classification process based on the rules. In this case, the classifier may determine multiple classification labels. The majority section 501 specifies a classification label most often determined by the classifier, and sends data including the content of the specified label to the output section 105.

While each of the embodiments has been described with respect to an RTCP-XR packet, the invention may be achieved with other packets that include information on data-flow control and the source and destination thereof.

What is claimed is:

1. A network fault detection system comprising:
a parameter extractor configured to extract a parameter value of a parameter for use in a classification feature vector from a packet received from a network, the parameter value relating to at least one of a first value for a first parameter associated with loss of packets, a second value for a second parameter associated with jitter among packets, and a third value for a third parameter associated with a characteristic of an occurrence of the loss of packets; and
a fault classifier configured to determine whether or not a fault has occurred in the network and classify the fault by type, based on numerical conditions and the parameter value.

2. The network fault detection system according to claim 1, wherein the parameter value also relates to a fourth value for a fourth parameter associated with transmission delays of packets.

3. The network fault detection system according to claim 1,
wherein the second value corresponds to at least one of a mean value, a deviation value, and a maximum value of the jitter among packets in a statistical period, and
wherein the third value corresponds to at least one of a value associated with a length of a burst period, a value associated with a percentage of packets lost in the burst period, and a value associated with a percentage of packets lost in a period other than the burst period in the statistical period.

4. The network fault detection system according to claim 3, further comprising a classification condition memory configured to store a classification rule that defines the numerical conditions, an order in which the numerical conditions are applied, and a classification label showing a state of the network.

5. The network fault detection system according to claim 4, wherein the fault classifier determines that a wireless link failure has occurred in the network, when the following conditions in the classification rule are satisfied:
(a) the mean value and the deviation value of the jitter among packets in the statistical period are within a predetermined range,
(b) the value associated with the percentage of packets lost in the statistical period other than the burst period is less than or equal to a first reference value,
(c) the value associated with the percentage of packets lost in the burst period is greater than a second reference value, and
(d) the value associated with the length of the burst period is less than or equal to a third reference value.

6. The network fault detection system according to claim 4, wherein the classification condition memory stores a plurality of the classification rules, and the fault classifier classifies the fault based on the classification rules.

7. The network fault detection system according to claim 6, further comprising a majority section configured to specify a fault that has occurred most frequently.

8. The network fault detection system according to claim 4, further comprising a setting section configured to cause the classification condition memory to store the classification rule.

9. The network fault detection system according to claim 4, further comprising a classification rule generator configured to generate the classification rule based on the classification feature vector and the classification label.

10. The network fault detection system according to claim 9, wherein the classification rule generator generates the classification rule with a data mining technique.

11. The network fault detection system according to claim 10, wherein the classification rule generator generates the classification rule with one of a decision tree, a support vector machine, a neural network, a Bayesian network, and a random forest.

12. The network fault detection system according to claim 3, wherein the packet is an RTCP-XR packet.

13. The network fault detection system according to claim 12,
wherein the first parameter corresponds to lost-packets, loss-rate, and discard-rate,
wherein the second parameter corresponds to mean-jitter, deviation-jitter, and max-jitter, and
wherein the third parameter corresponds to burst-duration, burst-density, and gap-density.

14. The network fault detection system according to claim 13,
wherein the mean-jitter, the deviation-jitter and the max-jitter respectively include the mean value, the deviation value and the maximum value of the jitter among packets in the statistical period, and
wherein the burst-duration, the burst-density, and the gap-density respectively include the value associated with the length of the burst period, the value associated with the percentage of packets lost in the burst period, and the value associated with the percentage of packets lost in the statistical period other than the burst period.

15. The network fault detection system according to claim 1, further comprising:
a packet receiver configures to receive a plurality of packets flowing over the network; and
a packet selector configured to select the packet from the plurality of packets and send the packet to the parameter extractor.

16. The network fault detection system according to claim 1, further comprising a counter configured to count the number of faults based on results of classification by the fault classifier.

17. The network fault detection system according to claim 16, the counter counts the number of faults with respect to each pair of IP addresses of a transmitting device and a receiving device.

18. The network fault detection system according to claim 16, the counter counts the number of faults with respect to each of a plurality of autonomous systems.

19. A network fault detection system for use with a network, comprising:
a computer that communicates with the network, the computer including
a parameter extractor that extracts parameter values from a packet received from the network, the parameter values extracted from the packet being selected from a group that includes parameter values associated with loss of packets, parameter values associated with jitter among packets, parameter values associated with an occurrence of the loss of packets, and parameter values associated with transmission delays; and
a fault classifier that determines whether or not a fault has occurred based at least in part on the parameter values extracted from the packet received from the network and a classification rule that employs the parameter values extracted from the packet received from the network.
